(19) United States
(12) Patent Application Publication
(10) Pub. No.: US 2026/0170373 A1
(43) Pub. Date: Jun. 18, 2026

(54) OPTIMIZED TWO-LEVEL-SYSTEM BIAS PERFORMANCE OVER MEASUREMENT HISTORY

(71) Applicant: International Business Machines Corporation, Armonk, NY (US)

(72) Inventors: Jerry David Tersoff, Blauvelt, NY (US); James B Hannon, Mahopac, NY (US); Sami Rosenblatt, White Plains, NY (US)

(21) Appl. No.: 18/980,539

(22) Filed: Dec. 13, 2024

(51) Int. Cl. G06N 10/20

(52) U.S. Cl. CPC G06N 10/20

(57) ABSTRACT

One or more systems, devices, computer program products and/or computer-implemented methods of use provided herein relate to optimizing performance of TLS biases. For example, a system can comprise a memory that can store computer executable components and a processor that can execute the computer executable components stored in the memory. The computer executable components can comprise a measurement component that can obtain a reference dataset of measurements. The computer executable components can further comprise a training component that can determine, from the reference dataset of measurements, a set of parameters and a set of hyperparameters of a machine learning model. The computer executable components can further comprise a prediction component that can predict, via the machine learning model configured with the set of parameters and the set of hyperparameters, a set of TLS biases of a quantum system that minimizes a cost function based on prior measurements.

### BACKGROUND

The subject disclosure relates to quantum computing and, more specifically, to optimizing two-level-system bias performance over measurement history in quantum computing.

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later. In one or more embodiments described herein, systems, computer-implemented methods, apparatus and/or computer program products that enable optimized two-level-system (TLS) bias performance over measurement history are discussed.

According to an embodiment, a system is provided. The system can comprise a memory that can store computer executable components. The system can further comprise a processor that can execute the computer executable components stored in the memory, where the computer executable components can comprise a measurement component that can obtain a reference dataset of measurements. The computer executable components can further comprise a training component that can determine, from the reference dataset of measurements, a set of parameters and a set of hyperparameters of a machine learning model. The computer executable components can further comprise a prediction component that can predict, via the machine learning model configured with the set of parameters and the set of hyperparameters, a set of TLS biases of a quantum system that minimizes a cost function based on prior measurements.

According to various embodiments, the above-described system can be implemented as a computer-implemented method or as a computer program product.

### BRIEF DESCRIPTION OF THE DRAWINGS

One or more embodiments are described below in the Detailed Description section with reference to the following drawings:

FIG. 1 illustrates a block diagram of an example, non-limiting system that can facilitate optimized TLS bias performance over measurement history in accordance with one or more embodiments described herein.

FIG. 2 illustrates another block diagram of an example, non-limiting system that can facilitate optimized TLS bias performance over measurement history in accordance with one or more embodiments described herein.

FIG. 3 illustrates a diagram of example, non-limiting diagram of hyperparameters in accordance with one or more embodiments described herein.

FIG. 4 illustrates a block diagram of an example, non-limiting system for dividing qubits into batches in accordance with one or more embodiments described herein.

FIG. 5 illustrates a diagram of an example, non-limiting representation showing dividing qubits into batches in accordance with one or more embodiments described herein.

FIG. 6 illustrates a block diagram of an example, non-limiting system that can be employed to dynamically switch quantum circuit layouts in accordance with one or more embodiments described herein.

FIG. 7 illustrates a diagram of an example, non-limiting graphs of TLS bias over time in accordance with one or more embodiments described herein.

FIG. 8 illustrates a diagram of an example, non-limiting graph of TLS bias selection performance in accordance with one or more embodiments described herein.

FIG. 9 illustrates an example, non-limiting block diagram of a training dataset in accordance with one or more embodiments described herein.

FIG. 10 illustrates an example, non-limiting block diagram showing how a machine learning model can be trained in accordance with one or more embodiments described herein.

FIG. 11 illustrates a flow diagram of an example, non-limiting method 1300 that can facilitate optimized TLS bias performance over measurement history in accordance with one or more embodiments described herein.

FIG. 12 illustrates a flow diagram of an example, non-limiting method 1300 that can facilitate optimized TLS bias performance over measurement history in accordance with one or more embodiments described herein.

FIG. 13 illustrates a flow diagram of an example, non-limiting method 1300 that can facilitate optimized TLS bias performance over measurement history in accordance with one or more embodiments described herein.

FIG. 14 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

According to an embodiment, a system is provided. The system can comprise a memory that can store computer executable components. The system can further comprise a processor that can execute the computer executable components stored in the memory, where the computer executable components can comprise a measurement component that can obtain a reference dataset of measurements. The computer executable components can further comprise a training component that can determine, from the reference dataset of measurements, a set of parameters and a set of hyperparameters of a machine learning model. The computer executable components can further comprise a prediction component that can predict, via the machine learning model configured with the set of parameters and a set of hyperparameters, a set of two-level-system (TLS) biases of a quantum system that minimizes a cost function based on prior measurements.

Such embodiments of the system can provide a number of advantages, including improving error rates in quantum systems, providing a strategy to periodically update TLS biases to mitigate errors from TLS fluctuations over time, improving error rate stability, and providing a strategy to optimize TLS biases while maintaining a desirable overhead.

In one or more embodiments of the aforementioned system, the set of hyperparameters can comprise at least one of: an update schedule of measurements, an update schedule of the set of TLS biases, types of measurements, or internal parameters of measurements.

Such embodiments of the system can provide the advantage of providing optimized hyperparameters for different cost functions associate with different target applications and providing a strategy to determine optimal TLS bias update schedules for mitigating errors from TLS fluctuations over time.

In one or more embodiments of the aforementioned system, the training component can train the machine learning model to minimize the cost function using the reference dataset, wherein the reference dataset comprises TLS biases and corresponding performance data over a period of time.

Such embodiments of the system can provide the advantage of determining optimal parameters and hyperparameters of the machine learning model by using all available historical measurements.

In one or more embodiments of the aforementioned system, the training component can independently adjust the set of parameters or the set of hyperparameters for individual qubits of the quantum system.

Such embodiments of the system can provide a number of advantages, including improving accuracy of TLS biases prediction, enabling more precise modeling of TLS effects specific to each qubit, and enabling targeted error mitigation strategies to improve overall error rates of the quantum system.

In one or more embodiments of the aforementioned system, the training component can generate alternative sets of parameters and hyperparameters of the machine learning model based on a target application of the quantum system.

Such embodiments of the system can provide the advantage of enabling flexibility for error mitigation based on target applications. Such flexibility can be advantageous for providing optimized TLS biases across various applications and purposes, and for providing optimized TLS biases based on user priorities.

In one or more embodiments of the aforementioned system, the cost function can reflect the target application of the quantum system.

Such embodiments of the system can provide the advantage of enabling flexibility for error mitigation based on target applications. Such flexibility can be advantageous for providing optimized TLS biases across various applications and purposes, and for providing optimized TLS biases based on user priorities.

In one or more embodiments of the aforementioned system, the prior measurements can be interleaved with a target experiment on the quantum system.

Such embodiments of the system can provide a number of advantages, including improving error rates and improving error rate stability.

In one or more embodiments of the aforementioned system, the training component trains the machine learning model on crosstalk by generating controlled crosstalk in the reference dataset.

Such embodiments of the system can provide a number of advantages, including improving error mitigation on crosstalk by ensuring the set of hyperparameters are optimized to provide robust performance in the presence of crosstalk.

In one or more embodiments of the aforementioned system, generating controlled crosstalk in the reference dataset can comprise dividing qubits of the quantum system into two or more batches, wherein two-qubit gates involve qubits from different batches in the two or more batches. In one or more embodiments of the aforementioned system, generating controlled crosstalk in the reference dataset can further comprise independently scanning, on the quantum system, TLS biases on the two or more batches.

Such embodiments of the system can provide the advantages of optimizing quantum gates independently and improving error mitigation on crosstalk by training the machine learning model to predict, for any given set of biases, the expected error rate for every gate.

In one or more embodiments of the aforementioned system, the measurement component can scan a subset of all combinations of the TLS biases on the two or more batches.

Such embodiments of the system can provide a number of advantages, including optimizing quantum gates independently with manageable overhead and improving fidelity.

According to various embodiments, the above-described system can be implemented as a computer-implemented method or as a computer program product.

### Definitions:

Two-level-systems: TLSs are quantum mechanical systems that can exist in one of two states, commonly acting as sources of noise and errors in superconducting qubits due to their coupling with qubit states.

Superconducting qubits: Superconducting qubits are a type of qubit that relies on superconducting materials to achieve quantum coherence, enabling quantum computing operations.

Coherence Times: The duration for which a qubit can maintain its quantum state without significant loss of information due to environmental disturbances, such as noise from TLS.

Crosstalk: Unwanted interference between qubits or components in a quantum circuit, which can occur when one qubit's operations affect another due to shared connections or biasing.

Spectral Diffusion: The phenomenon where the frequencies of TLSs change over time, making it challenging to predict their effects on qubits.

In quantum computing, TLSs are a major source of noise and error in superconducting qubits. TLSs can arise from defects in materials, junction interfaces, or surrounding dielectrics. These parasitic quantum states couple to qubits, affecting their performance by introducing fluctuations in frequency and coherence times. To mitigate these errors, biasing techniques, such as static or dynamic voltage adjustments, or mechanical strain, are often used to mitigate the impact of TLSs on qubit performance. However, TLS behavior is unpredictable, with individual TLSs exhibiting distinct time-varying properties, which complicates finding optimal biasing strategies. The challenge is not only in identifying an effective bias but in dynamically updating these TLS biases as TLS characteristics evolve over time, requiring an efficient TLS bias update strategy.

Existing schemes for finding optimal biases to mitigate TLS impact are largely ad hoc (e.g., unsystematic) and often rely heavily on trial-and-error. One major challenge is the variability in TLS behavior: a small number of strong TLSs can dominate circuit performance, making it difficult to obtain reliable (e.g., representative) statistics. Some TLSs fluctuate rapidly, making them challenging to track and mitigate in real time, while others remain stable over longer periods. Such irregular behavior, often referred to as “spectral diffusion,” adds complexity to bias optimization because it is difficult to predict how TLSs will evolve over time and, therefore, how biases should be updated to maintain qubit performance. Consequently, bias updates are often based on incomplete data, leading to suboptimal performance.

Another issue is that updating biases can cause sudden changes in qubit error rates, disrupting system stability. Although AC biasing techniques (that employ time-varying bias values instead of a single updated value) can stabilize error rates, they prevent improvement in average qubit fidelity. Additionally, biasing a qubit can also affect other components, such as couplers, due to crosstalk. This makes it harder to isolate the effects of each TLS when testing bias strategies.

Since TLSs move over time, biases need to be updated periodically to ensure optimal qubit performance. However, frequent bias updates introduce significant overhead in terms of computational resources and experimental time. Thus, balancing the frequency of updates with the performance benefit is crucial. For example, infrequent updates may allow TLSs to degrade performance, while too many updates can introduce unnecessary disruptions and increase computational overhead. Furthermore, the benefit of mitigating the influence of a strong TLS may diminish if that TLS is no longer active or if it fluctuates out of range, making it difficult to quantify the long-term gains of any TLS biasing strategy.

Thus, methods and techniques (or schemes) that are more systematic to optimize TLS biases and provide an adaptive update strategy that considers TLS movement over time are desirable.

Various embodiments of the present disclosure can be implemented to produce a solution to these problems. Embodiments described herein include systems, computer-implemented methods, and computer program products that provide a method to optimize TLS biases using all available measurement history. In particular, various embodiments described herein can optimize a set of parameters and a set of hyperparameters over a reference dataset of measurements and predict, via the machine learning model, a set of TLS biases based on prior measurements used as input. Accordingly, various embodiments described herein can continuously update the TLS biases of a quantum system with the set of TLS biases predicted based on the prior measurements. The various embodiments described herein to optimize the TLS biases can provide a method for predicting TLS biases at any point in time of execution that can be advantageous in minimizing errors from the variability and rapid fluctuation of TLS effects while maintaining a desirable overhead. Such prediction and update procedure can stabilize error-rates in addition to reducing error-rates. The corresponding results provide a new and more effective approach to optimize TLS biases that can be more reliable and can reduce unnecessary overhead.

In various embodiments, a procedure to predict TLS biases while aiming to minimize overhead (e.g., overhead for measuring and then updating TLS biases) is also provided. That is, various embodiments described herein can update with TLS biases that provides maximum benefit (e.g., minimum error-rate) at a given overhead. It should be appreciated that the embodiments described herein can be generalized to minimize other computation goals besides overhead.

In various embodiments, the TLS bias optimization component can be employed to train the machine learning model to predict TLS biases and continuously update the TLS biases. For example, in various embodiments, a TLS bias optimization component can comprise a measurement component, a training component and a prediction component. In various embodiments, the measurement component can obtain a reference dataset of measurements. For example, the measurement component can obtain the reference dataset from all available measurement history and its corresponding TLS biases. In various embodiments, the training component can train a machine learning model to optimize parameters and hyperparameters using the reference dataset as a ground-truth. In various embodiments, the prediction component can predict, via the machine learning model configured with the parameters and hyperparameters, the set of TLS biases based on prior measurements obtained, by the measurement component. For instance, using the set of hyperparameters optimized using the reference dataset such as an update schedule of measurements, the measurement component can obtain the prior measurements (e.g., measurements over the past hour, measurements over the past minute). Accordingly, the prediction component can use the prior measurements as input to the machine learning model to generate a set of TLS biases. Such process can be continuously performed to predict and update the TLS biases based on the prior measurements.

In comparison to existing methods, the embodiments described herein for optimizing TLS biases provide more robust training for predicting TLS biases that can improve the performance while maintaining overhead costs. Such robust training results from the fact that the hyperparameters of the machine learning model are optimized over a reference dataset that comprises any available historical data. On the contrary, many existing methods are focused on tuning TLS biases based on a measurement. As a result, such existing methods do not address the time-dependence of TLS effects and thus incur additive overhead to optimize TLS biases with less improved error-rates. In the various embodiments of the present disclosure, the optimization of an update schedule for the TLS biases and continuous prediction and updating of TLS biases can provide the advantage of more effective error mitigation with respect to the unpredictable variability of TLS effects. Such optimization results from training the machine learning model on the reference dataset of measurements to optimize a cost function. As a result, application of the embodiments disclosed herein is more promising for addressing the variability and rapid fluctuations of TLS behaviors. These advantages are described in greater detail with reference to one or more figures. Additionally, the various embodiments described herein can be widely adapted across various target applications by adjusting the hyperparameters based on a cost function that reflects the target application.

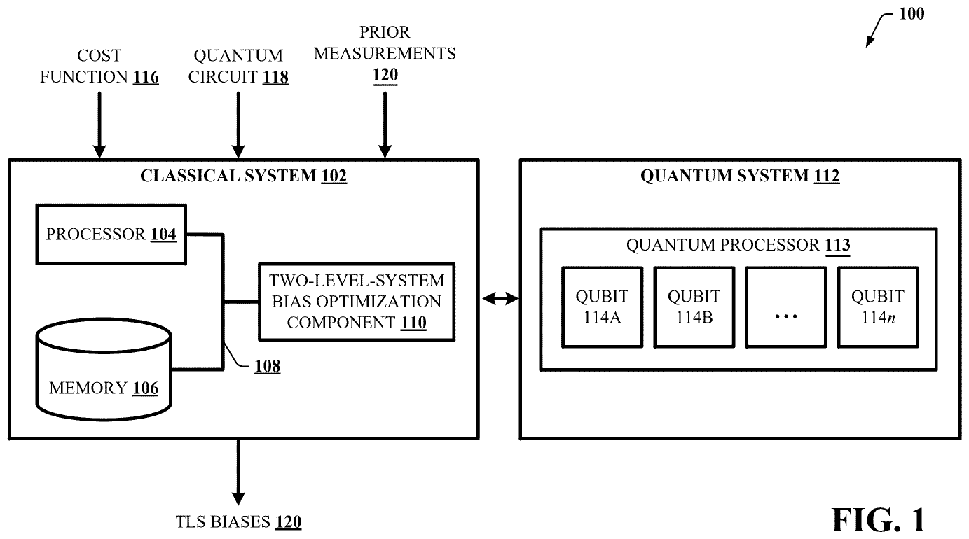

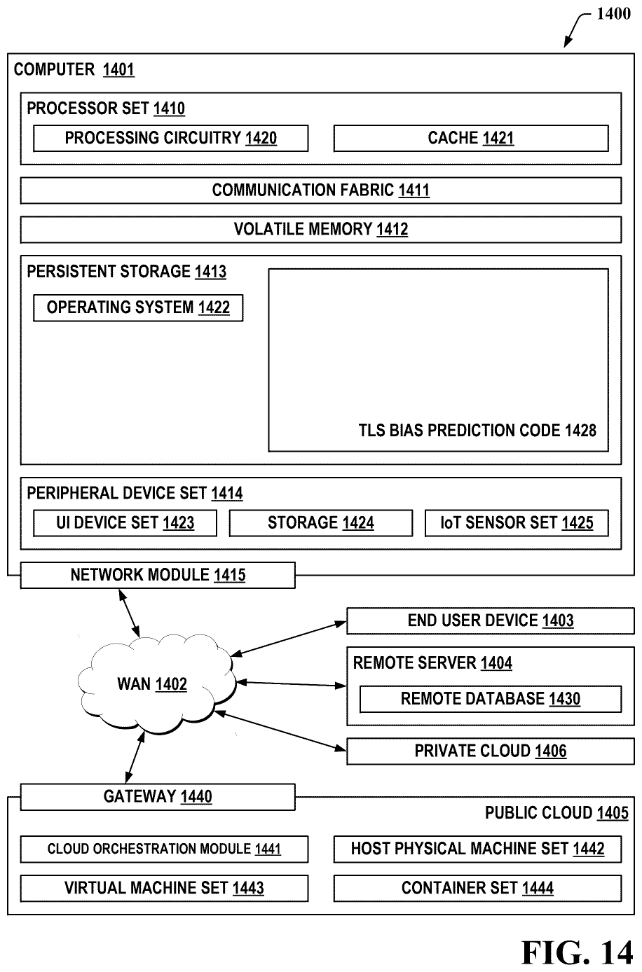

The embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 as illustrated at FIG. 1, and/or systems thereof, can further comprise, be associated with and/or be coupled to one or more computer and/or computing-based elements described herein with reference to an operating environment, such as the operating environment 1400 illustrated at FIG. 14. For example, non-limiting system 100 can be associated with, such as accessible via, a computing environment 1400 described below with reference to FIG. 14, such that aspects of processing can be distributed between non-limiting system 100 and the computing environment 1400. In one or more described embodiments, computer and/or computing-based elements can be used in connection with implementing one or more of the systems, devices, components and/or computer-implemented operations shown and/or described in connection with FIG. 1 and/or with other figures described herein.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. Additionally, the computer-implemented methodologies described hereinafter and throughout this specification are capable of being stored on an article of manufacture to enable transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

FIG. 1 illustrates a block diagram of an example, non-limiting system 100 that can facilitate optimized TLS bias performance over measurement history in accordance with one or more embodiments described herein.

Non-limiting system 100 and/or the components of non-limiting system 100 can be employed to use hardware and/or software to solve problems that are highly technical in nature (e.g., related to error mitigation, TLSs in quantum computing, TLS bias optimization, etc.), that are not abstract and that cannot be performed as a set of mental acts by a human. Further, some of the processes performed may be performed by specialized computers for carrying out defined tasks related to optimized TLS bias performance over measurement history. Non-limiting system 100 and/or components of non-limiting system 100 can be employed to solve new problems that arise through advancements in technologies mentioned above, computer architecture, and/or the like. Non-limiting system 100 can provide technical improvements to quantum computing systems by improving the overhead involved in optimizing TLS bias performance over measurement history, reducing error-rates, improving error-rate stability, providing continuous optimization of TLS biases, etc.

Discussion turns briefly to processor 104, memory 106 and bus 108 of non-limiting system 100. For example, in one or more embodiments, non-limiting system 100 can comprise processor 104 (e.g., computer processing unit, microprocessor, classical processor, and/or like processor). In one or more embodiments, a component associated with non-limiting system 100, as described herein with or without reference to the one or more figures of the one or more embodiments, can comprise one or more computer and/or machine readable, writable and/or executable components and/or instructions that can be executed by processor 104 to enable performance of one or more processes defined by such component(s) and/or instruction(s).

In one or more embodiments, non-limiting system 100 can comprise a computer-readable memory (e.g., memory 106) that can be operably connected to processor 104. Memory 106 can store computer-executable instructions that, upon execution by processor 104, can cause processor 104 and/or one or more other components of non-limiting system 100 (e.g., TLS bias optimization component 110, measurement component 202, training component 204, prediction component 206, reference dataset 208, and/or machine learning (ML) model 210) to perform one or more actions. In one or more embodiments, memory 106 can store computer-executable components (e.g., TLS bias optimization component 110, measurement component 202, training component 204, and/or prediction component 206).

Non-limiting system 100 and/or a component thereof as described herein, can be communicatively, electrically, operatively, optically and/or otherwise coupled to one another via bus 108. Bus 108 can comprise one or more of a memory bus, memory controller, peripheral bus, external bus, local bus, and/or another type of bus that can employ one or more bus architectures. One or more of these examples of bus 108 can be employed. In one or more embodiments, non-limiting system 100 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of non-limiting system 100 can reside in the cloud, and/or can reside locally in a local computing environment (e.g., at a specified location(s)).

As illustrated in FIG. 1, non-limiting system 100 can comprise classical system 102 and quantum system 112. Classical system 102 can be coupled (operatively, communicatively, electrically, and/or like function) to quantum system 112. Quantum system 112 can comprise at least one quantum processor, such as quantum processor 113. Classical system 102 can comprise one or more components, such as a memory 106, processor 104, bus 108, and/or TLS bias optimization component 110. In an embodiment, TLS bias optimization component 110 can be comprised at least partially by quantum system 112. Quantum processor 113 can comprise a quantum logic circuit comprising one or more qubits 114, such as qubit 114A, qubit 114B, . . . , qubit 114n, etc., where n represents a positive integer. Quantum processor 113 can be any suitable processor. Quantum processor 113 can generate one or more instructions for controlling the quantum logic circuit.

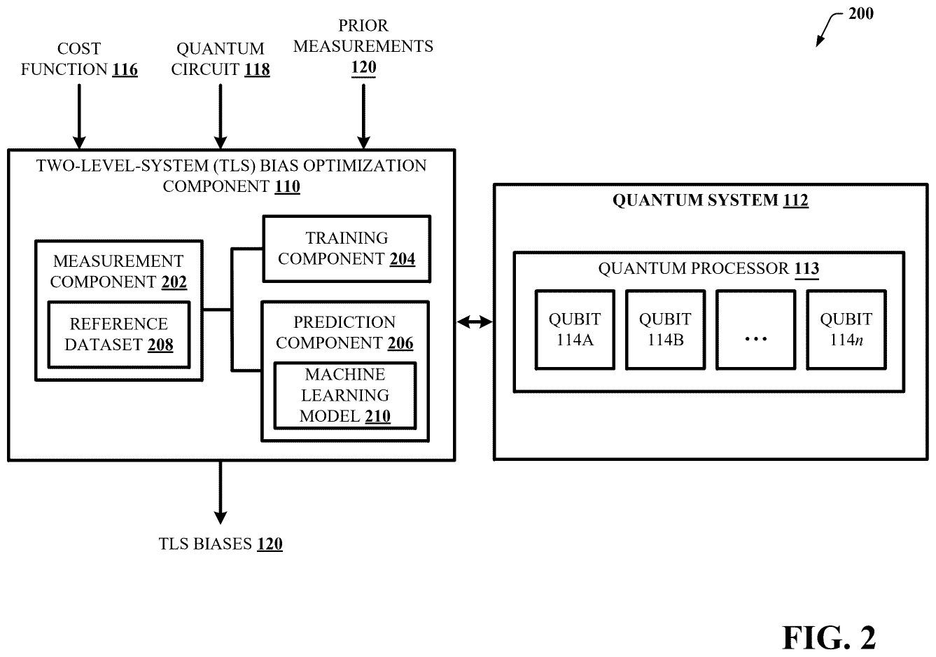

In various embodiments, TLS bias optimization component 110 can comprise measurement component 202, training component 204, and prediction component 206, as illustrated in FIG. 2. In various embodiments, measurement component 202 can obtain, as described herein, a reference dataset 208 of measurements. For instance, the reference dataset 208 can comprise any suitable historical data (e.g., any or all available historical data). As an example, the reference dataset 208 can comprise measurements taken over an extended period while varying the TLS biases (e.g., TLS bias parameters). As such, the reference dataset 208 can comprise TLS biases and performance data.

In various embodiments, training component 204 can facilitate, as described herein, model evaluation of ML model 210 using the reference dataset 208. Accordingly, training component 204 can determine a set of parameters and a set of hyperparameter of the ML model 210 based on the model evaluation. That is, training component 204 can train ML model 210 to predict a set of TLS biases by minimizing error between prediction of the TLS biases generated by ML model 210 and a ground-truth. In various aspects the ground-truth can be data from the reference dataset 208. That is, training component 204 can train ML model 210 by using reference dataset 208 as a ground-truth.

In various embodiments, after training (via training component 204) ML model 210 to a desired level of performance, prediction component 206 can, as described herein, receive prior measurements 120 obtained from quantum system 112 as input and generate a set of TLS biases 122 as output. In various instances, the prior measurements 120 can be obtained over any suitable shorter duration of time in comparison to the reference dataset 208. As a non-limiting example, the prior measurements 120 can be measured over the past few hours. As another non-limiting example, the prior measurements 120 can be measured over the last hour. As yet another non-limiting example, the prior measurements 120 can be measured over the past 30 minutes. In any instance, the prior measurements 120 can comprise measurements obtained over a defined time interval such that the end of the time interval is a current time. In other words, the prior measurements 120 can comprise measurements obtained over a most recent and defined time interval.

In various aspects, prediction component 206 can employ ML model 210 to predict the dependence of cost on TLS biases 122, wherein the TLS biases 122 are chosen to minimize a cost function 116. The training component can quantify an error between the cost versus TLS biases 122 predicted by ML model 210 and a ground-truth cost vs TLS biases to guide performance optimization of the ML model 210. In various embodiments, prediction component 206 can receive cost function 116. In various cases, the cost function 116 can represent or correspond to any desired performance outcomes. For instance, the cost function 116 can reflect various cost models based on different applications or performance goals. As a non-limiting example, if quantum error mitigation is the desired application (e.g., the target application), such as probabilistic error cancellation (PEC), the cost function can include a cost for variability of error rates of individual quantum gates. Conversely, in applications without quantum error mitigation, the cost function 116 can include penalties to layer fidelity or average error rates. In various aspects, the cost function 116 can reflect any desired trade-offs for any desired application, such as a trade-off between layer fidelity and overhead. For example, based on the desired application, the trade-off between fidelity and overhead can differ (e.g., can differ for cutting-edge demonstrations where better performance is desired over overhead costs). In any case, measurement component 202 can implement the TLS biases 122 (e.g., via ML 210) based on a desired performance reflected in the cost function 116 using quantum circuit 118.

In various aspects, the TLS biases 122 can be TLS tuning parameters that can manipulate or alter the TLS environment. As a non-limiting example, the TLS biases 122 can include shifting the frequencies of TLSs. In various embodiments, measurement component 202 can implement the TLS biases 122 by adjusting the TLS tuning parameters via any suitable method. As a non-limiting example, the TLS biases 122 can be implemented using an electrical field (e.g., adjusting voltages of electrical pads to supply the electric field). As another non-limiting example, the TLS biases 122 can be implemented using mechanical strain (e.g., piezo electronics to control the TLSs through lattice deformation).

In various embodiments, a target application of the quantum system 112 can be reflected in the cost function 116. Based on the target application, training component 204 can generate alternative sets of parameters and hyperparameters of the ML model 210. That is, training component 204 can generate alternative sets of parameters and hyperparameters of the ML model 210 for multiple cost functions that reflect various different target applications. For each new cost function 116 received, training component 204 can generate the alternative sets of parameters and hyperparameters. Conversely, for cost functions previously received, training component 204 can switch models to correspond to the cost function 116 in use. That is, training component 204 can adjust the parameters and hyperparameters of the ML model 210 to the corresponding alternative sets of parameters and hyperparameters of the ML model 210.

FIG. 2 illustrates a block diagram of an example, non-limiting system 200 that can facilitate optimized TLS bias performance over measurement history in accordance with one or more embodiments described herein. Repetitive description of like elements and/or processes employed in respective embodiments is omitted for sake of brevity.

As described with reference to FIG. 1, TLS bias optimization component 110 can comprise measurement component 202, training component 204 and prediction component 206. In this regard, non-limiting system 200 describes the system of TLS bias optimization component 110 and quantum system 112 that can facilitate optimize performance of TLS bias.

In various embodiments, measurement component 202 can obtain reference dataset 208 through continuous scanning of the TLS bias applied to the quantum system 112, recording how the quantum system 112 responds under different TLS bias conditions. Thus, the reference dataset 208 can capture dynamic behavior of the system as a function of bias variations, providing a comprehensive overview of bias-performance relationships. In various cases, the reference dataset 208 can include time-series data, TLS bias levels, and corresponding system performance metrics, serving as a detailed record of system characteristics under varied TLS biases.

As a non-limiting example, the measurements in the reference dataset 208 can include multiple Clifford lengths, for increased accuracy. Clifford lengths refer to sequences of operations from the Clifford group, which are commonly used in quantum error correction and benchmarking. By including various Clifford lengths, the reference dataset 208 can capture the system's performance across a broader range of quantum operations, thereby providing a more comprehensive evaluation. These measurements can allow for finer granularity in assessing the impact of TLS biases on system stability and error rates. Then, for any given model (e.g., any model of a large class of candidate models) and its associated hyperparameters (e.g., ML model 210 and associated hyperparameters and/or parameters), performance can be evaluated by analyzing how well the model predicts or fits the system behavior across these diverse Clifford length sequences, leading to more accurate modeling and system characterization.

As another non-limiting example, the measurements in the reference dataset 208 can include error rates associated with various gate configurations employed in the quantum system 112. By systematically varying the gate types and their arrangements, the reference dataset 208 can capture the performance metrics related to TLS biases under different operational contexts. This allows for a comprehensive assessment of how specific gate configurations influence the quantum system's reliability and error rates. Consequently, when evaluating candidate models (e.g., machine learning model 210) and their hyperparameters, this information can reveal which configurations mitigate TLS biases most effectively, leading to improved model accuracy and predictive power.

As yet another non-limiting example, the reference dataset 208 can include measurements taken at various temperature levels. Since TLS biases can be sensitive to environmental factors, recording performance metrics across a range of temperatures helps in understanding the thermal dynamics affecting the quantum system 112. By analyzing how the quantum system 112 behaves under different temperature conditions, candidate models (e.g., ML model 210) can be assessed for their ability to account for thermal-induced variations in TLS biases. Such multi-faceted approach can enhance the robustness of the model evaluation process, allowing for a more nuanced understanding of the interplay between temperature, TLS biases, and quantum system performance.

It should be noted that although the non-limiting examples described herein relate to obtaining measurements with varying Clifford lengths, error rates, and temperature levels to produce reference dataset 208, any suitable historical measurement data can be collected or obtained to make up reference dataset 208 (e.g., pulse width variations, decoherence times, drive amplitude levels, initialization states, measurement strategies, environmental noise levels).

In various embodiments, measurement component 202 can obtain the reference dataset 208 by implementing a series of controlled experiments where the quantum system 112 is subjected to such varying parameters. For instance, measurement component 202 can scan the TLS biases by systematically varying the TLS biases applied to quantum system 112 in order to observe and record the resulting performance metrics.

In various embodiments, measurement component 202 can introduce crosstalk into the reference dataset 208 to enable training of ML model 210 on handling crosstalk effects. Specifically, measurement component 202 can alternate TLS bias scans where all qubits have identical TLS biases with scans where neighboring qubits have their TLS biases reversed, allowing the model to learn how crosstalk manifests under different bias configurations. In other instances, measurement component 202 can alternate scans where all TLS biases are the same with scans where TLS biases are varied across qubits. This deliberate introduction of different bias patterns enables the ML model 210 to observe how changing TLS biases affects crosstalk, improving its ability to predict and mitigate crosstalk in real-time quantum operations. By incorporating such varied TLS bias configurations, the ML model 210 can become more robust in understanding the interaction between qubits and external factors, allowing it to optimize the hyperparameters of ML model 210 in environments where crosstalk is present.

In various embodiments, after obtaining reference dataset 208, training component 204 can optimize the set of hyperparameters (e.g., 302) of the ML model 210. Specifically, training component 204 can perform model evaluation of the ML model 210 using reference dataset 208 to optimize the set of hyperparameters.

In various instances, training component 204 can adjust the set of parameters (or hyperparameters) of ML model 210 for each qubit individually. In other words, training component 204 can optimize the set of parameters for individual qubits to improve TLS bias performance for each TLS-qubit interaction environment. As a non-limiting example to achieve this, the hyperparameters and parameters can comprise parameters that are specific to each qubit (e.g., learning rates, regularization strengths, update frequencies). As another non-limiting example, qubit-specific feedback from feedback mechanisms can be utilized.

The procedure employed by training component 204 to facilitate model evaluation of ML model 210 for optimizing the set of hyperparameters can be elaborated as follows.

In various aspects, training component 204 can down sample the reference dataset 208 to simulate the data collection that would occur under the ML model 210 configured with the set of hyperparameters 300 (and/or a set of parameters). This can be advantageous in allowing for a realistic assessment of how the ML model 210 would perform in practice for various applications. Down sampling reference dataset 208 can involve extracting a subset of reference dataset 208.

Thereafter, in various embodiments, training component 204 can predict the cost vs TLS biases for one or more-time steps using the ML model 210 with the associated hyperparameters that are currently selected. Thus, training component 204 can evaluate performance of the ML model 210 by comparing the performance results obtained using the selected TLS biases against the reference dataset 208, which serves as the ground-truth. In various cases, training component 204 can iteratively compare the performance results and update the hyperparameters of ML model 210 based on the model evaluation, minimizing the error between the predicted TLS biases and the ground-truth. By minimizing the error between the predicted TLS biases and the ground-truth, training component 204 can optimize the hyperparameters of the ML model 210.

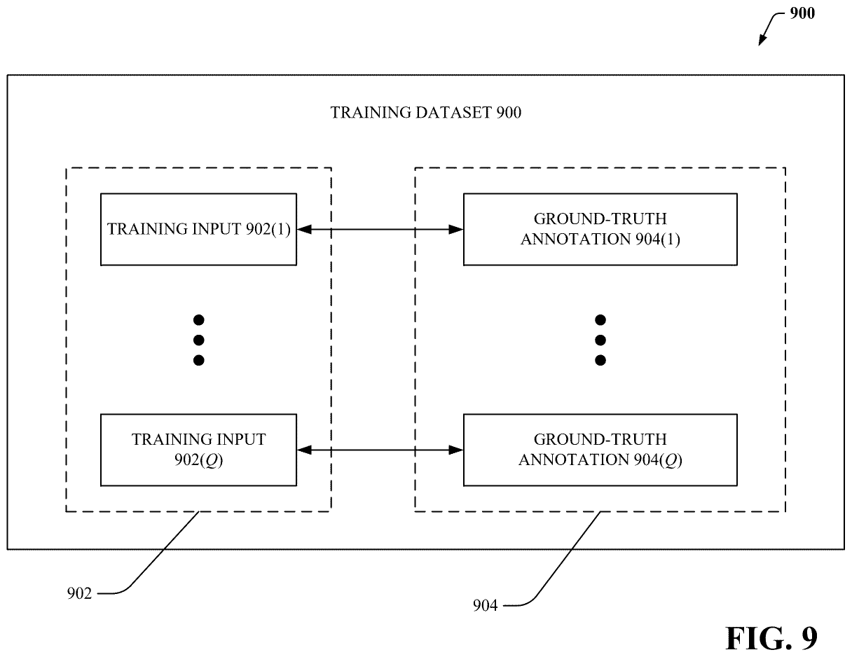

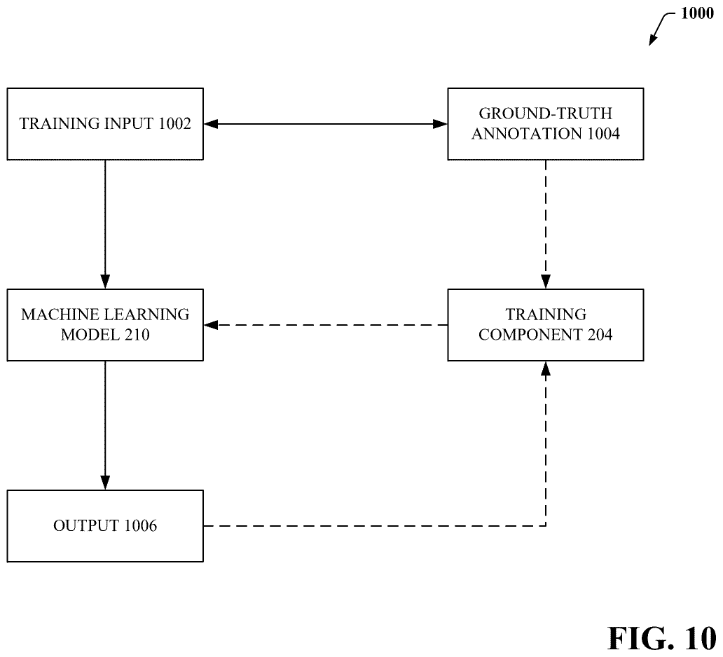

As a result, prediction component 206 can employ ML 210 with the optimized hyperparameters to predict TLS biases that minimize the cost function to provide optimized TLS biases. In various embodiments, the prediction component 206 can electronically store, maintain, control, or otherwise access the ML model 210 that can be configured to predict TLS biases 122 based on input prior measurements 120. In various aspects, the ML model 210 can exhibit any suitable artificial intelligence architecture (e.g., a deep learning neural network architecture) and can be trained in any suitable fashion, as described herein with respect to at least FIGS. 9 and 10.

More specifically, an input layer of the ML model 210 can receive prior measurements 120. The prior measurements 120 can complete a forward pass through one or more hidden layers of the ML model 210, and an output layer of the ML model 210 can generate the TLS biases 122 based on activations provided by the one or more hidden layers. In various aspects, the TLS biases 122 can have any suitable format, size, or dimensionality. Accordingly, measurement component 202 can apply the TLS biases 122 to optimize performance and reduce errors.

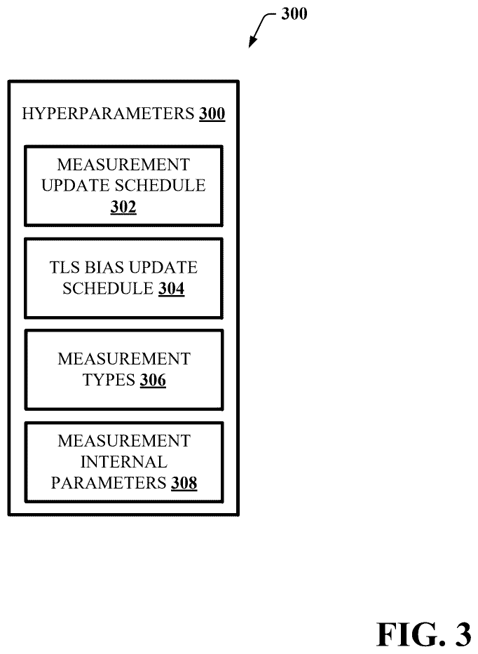

FIG. 3 illustrates a block diagram of example, non-limiting hyperparameters 300 of a machine learning model in accordance with one or more embodiments described herein. Repetitive description of like elements and/or processes employed in respective embodiments is omitted for sake of brevity.

In various embodiments, non-limiting hyperparameters 300 of ML model 210 can include measurement update schedule 302, TLS bias update schedule 304, measurement types 306, and measurement internal parameters 308.

The measurement update schedule 302 is an update schedule that determines how often data is collected from quantum system 112 (e.g., the frequency of obtaining measurements). For example, measurements can be taken after each Clifford operation or after every 50 shots (repeated executions of the same quantum circuit).

By determining and optimizing the measurement update schedule 302 using the reference dataset 208, the measurement update schedule 302 can be adjusted to determine the optimal frequency for taking measurements without disturbing the system's performance. For example, frequent measurements may offer more granular feedback for the ML model 210 but could also increase system overhead and introduce measurement-induced errors. On the other hand, infrequent measurements may miss important fluctuations or trends in the system's performance. In various aspects, by utilizing reference dataset 208 in hyperparameter optimization, training component 204 allow the ML model 210 to optimize the measurement update schedule 302 by analyzing past measurement data, enabling the ML model 210 to fine-tune how often measurements should be taken to capture system dynamics without overloading the system.

Similarly, TLS bias update schedule 304 is an update schedule that determines when measurement data is collected during quantum operations (e.g., how frequently measurements are taken). In various embodiments, the TLS bias update schedule 304 can be fixed, such as updating biases every 100 gate operations, or dynamic, where updates are triggered based on real-time system feedback like increased error rates.

By determining and optimizing the TLS bias update schedule 304 using the reference dataset 208, the TLS bias update schedule 304 can be tuned to balance stability and responsiveness. For example, if the TLS biases are updated too frequently, the system might become unstable due to overcorrection, while infrequent updates could allow for performance degradation. In various aspects, training component 204 can utilize the reference dataset 208 to evaluate different frequencies by comparing the system's error rates and fidelity over various intervals. Optimization using the reference dataset 208 as ground-truth data can provide the advantage of leveraging historical performance data to identify patterns in system behavior, leading to more informed decisions on when to update the TLS biases, thereby improving overall system stability and performance. In some cases, the measurement update schedule 302 can be the same or differ from TLS bias update schedule 304.

The measurement types 306 refer to the specific kinds of data collected from the quantum system to assess its performance. For example, measurement types 306 can include Two-Qubit Randomized Benchmarking (TQRB), which evaluates the fidelity of two-qubit gates, and Single-Qubit Randomized Benchmarking (SQRB), which focuses on single-qubit gate fidelity. As another example, measurement types 306 can include T1, where T1 is a measurement that represents the relaxation time of a qubit, indicating how long the qubit remains in its excited state before decaying to the ground state. The measurement types 306 can provide critical insights into the performance of the quantum system 112 under different operational conditions and TLS biases. In various aspects, the ML model 210 can use this data to understand how the quantum system 112 responds to different configurations, optimizing the TLS bias update schedule 304 and measurement update schedule 302 accordingly.

The measurement internal parameters 308 refer to specific settings used during quantum system measurements. For example, measurement internal parameters 308 can include Clifford length. Clifford length is the number of Clifford gates applied in a sequence during randomized benchmarking, directly influencing how the system's error rates and gate fidelities are assessed. As another example, measurement internal parameters 308 can include the number of shots, or the number of times the quantum circuit 118 is repeated. In various aspects, training component 204 can tune the measurement internal parameters 308 using the reference dataset 208, allowing ML model 210 to better assess the quantum system's performance under different TLS bias conditions. This can be achieved as the reference dataset 208 provides historical performance data that allows the ML model 210 to analyze the impact of, for example, different Clifford lengths and number of shots, optimizing these parameters to capture system behavior accurately.

In various aspects, leveraging the reference dataset 208 can allow for optimizing the TLS bias update schedule 304, measurement update schedule 302, measurement types 306, and measurement internal parameters 308 by providing historical data that helps fine-tune such non-limiting hyperparameters 300, leading to improved accuracy, reduced errors, and more efficient system performance. As non-limiting hyperparameters 300 of ML model 210, the measurement update schedule 302, the TLS bias update schedule 304, the measurement types 306, and the measurement internal parameters 308 can be optimized using the model evaluation process described with respect to FIG. 2.

Further, in various embodiments, to leverage the differences between qubits that persist over weeks or months due to strong, slowly fluctuating TLSs, training component 204 can divide the hyperparameters of ML model 210 into global hyperparameters and local hyperparameters. Global hyperparameters, such as measurement update schedule 302 or TLS bias update schedule 304, be applied at the device level. Conversely, local hyperparameters can be hyperparameters that use the historical measurement history to predict the TLS biases 122. If there is a sufficient amount of data in reference dataset 208 (e.g., sufficient training data), the training component 204 can optimize the local hyperparameters independently for each qubit 114 in quantum system 112. In cases where the reference dataset 208 is insufficient, measurements accumulated during routine quantum operations, although less comprehensive, can be used to tune the non-limiting hyperparameters 300 of each qubit or quantum gate for improved performance.

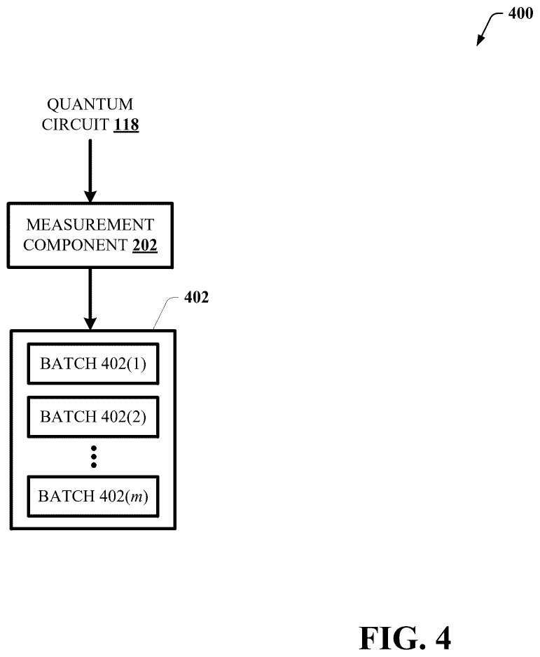

FIG. 4 illustrates a block diagram of an example, non-limiting system 400 for dividing qubits into batches in accordance with one or more embodiments described herein. Repetitive description of like elements and/or processes employed in respective embodiments is omitted for sake of brevity.

With continued reference to the embodiments of FIGS. 1 and 2, the measurement component 202 can optimize the TLS biases 122 for two-qubit gates with crosstalk. As described with respect to FIG. 2, training component 204 can train ML model 210 to account for crosstalk. Thus, by incorporating crosstalk into training data (e.g., reference dataset 208), the hyperparameters (e.g., non-limiting hyperparameters 300) can be determined or tuned to provide robust performance in the presence of crosstalk in the quantum system 112. In various embodiments, measurement component 202 can further address crosstalk in two-qubit gates when predicting TLS biases 122 by dividing the qubits 114 into batches. In other words, measurement component 202 can divide the qubits 114 into subsets.

For two-qubit gates, especially in a fast-flux device, the TLS bias applied at one qubit can significantly affect the coupler. For a specific two-qubit gate, the TLS biases 122 on the two qubits involved in the two-qubit gate can be determined to optimize fidelity. However, if each qubit participates in more than one quantum gate, the quantum gates cannot be optimized for independently. Therefore, to address such a problem, measurement component 202 can divide the qubits 114 into batches 402. That is, measurement component 202 can receive quantum circuit 118 and determine the batches 402 according to the quantum gates in quantum circuit 118, and instead scan combinations of TLS biases on the respective batches 402. There can be any suitable number of batches 402. For instance, there can be a m batches: a batch 402(1) to a batch 402(m).

In various aspects, measurement component 202 can divide the qubits 114 into batches 402 such that each two-qubit gate involves qubits from different batches of the batches 402. Then, instead of scanning n TLS biases (e.g., scanning TLS biases over each batch of batches 402), measurement component 202 can scan all combinations of the n TLS biases on the batches 402. As an example, if there are 3 batches (e.g., m=3), scanning all combinations of TLS biases would necessitate n³ full-device measurements. In general, to scan all combinations of the n TLS biases, n^{m} full-device measurements would be needed as opposed to n full-device measurements. Thus, to make such approach practical, measurement component 202 can use a reduced n. In addition, measurement component 202 can use a use a heuristic to sample a subset of the n^{m} combinations of TLS biases that is more manageable and practical to implement. For example, if most qubits have only 2 gates, but a small fraction have 3 gates, measurement component 202 can use 2 batches and still capture all combinations of biases for most (but not all) gates. Thereafter, this can allow training component 204 to train ML model 210 to

predict, for any given set of TLS biases, the expected error rate for each quantum gate in quantum circuit 118. Furthermore, this can be included in the cost function 116 as a cost to be minimized, such as layer fidelity. In various embodiments, to predict a set of TLS biases that minimizes the cost function, prediction component 206 can utilize, for example, gradient descent (e.g., adjusts TLS biases incrementally in the direction that reduces the cost). As another example, prediction component 206 can leverage a sparse coupling matrix (e.g., a matrix that indicates which qubits are strongly interacting) to simplify the search space, thereby improving processing efficiency to determine the set of TLS biases 122 that are optimal for each qubit.

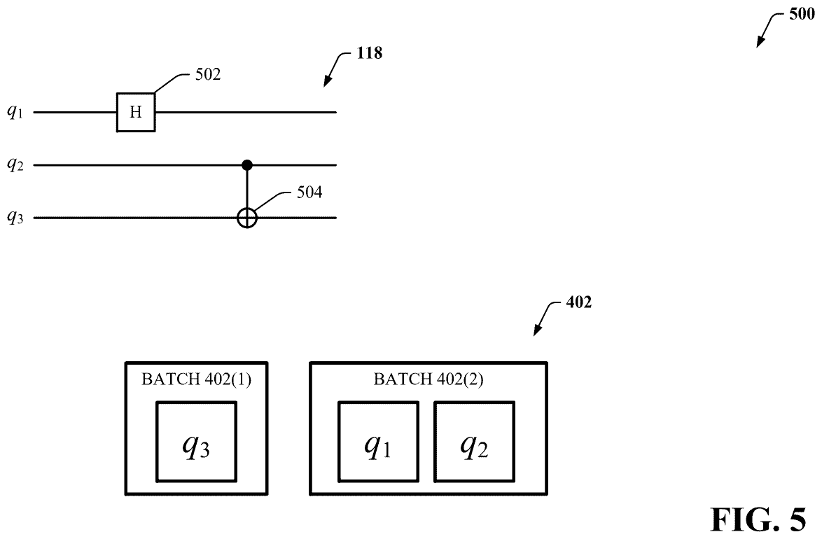

FIG. 5 illustrates a diagram of an example, non-limiting representation 500 showing dividing qubits into batches in accordance with one or more embodiments described herein. Repetitive description of like elements and/or processes employed in respective embodiments is omitted for sake of brevity.

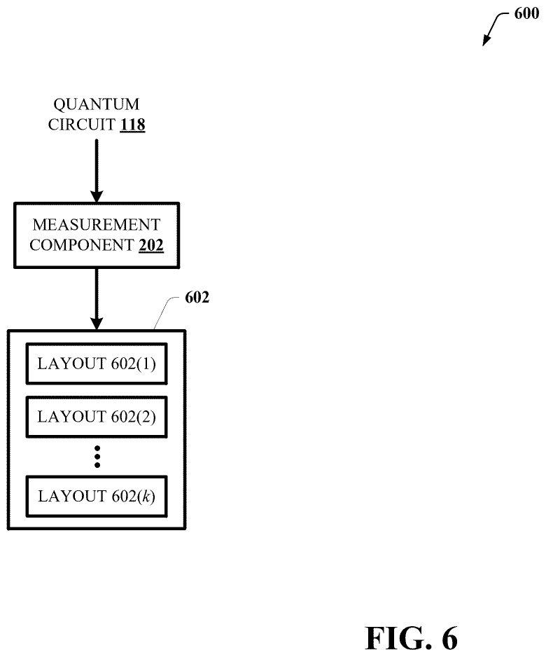

In reference to at FIG. 4, FIG. 5 depicts a non-limiting example of dividing the qubits 114 to facilitate optimization of TLS biases 122 for two-qubits gates with crosstalk. As a non-limiting example, quantum circuit 118 can comprise three qubits. That is, qubits 114 can consist of three qubits denoted by q₁, q₂, and q₃ respectively. Further, there can be a single qubit gate 502, such as a Hadamard gate, acting on q₁, and a two-qubit gate 504, such as a controlled Not (CNOT), acting on q₂ and q₃. As a result, there can be crosstalk between q₂ and q₃, which can degrade the performance and fidelity of quantum operations by introducing errors that affect the accuracy of quantum computations. Therefore, it can be desirable to adjust TLS biases 122 for each qubit to mitigate crosstalk by optimizing the control signals for individual qubits, thereby reducing unwanted interactions and improving overall quantum gate fidelity. To achieve this, measurement component 202 can divide the qubits 114 into batches 402 where q₂ and q₃ are in different batches. For example, measurement component 202 can assign q₃ to batch 402(1) and can assign q₁ and q₃ to batch 402(2). Note that, this a mere non-limiting example, and any suitable configuration or assignments of qubits 114 to batches 402 can be utilized to cause qubits acted on by a same two-qubit gate to be in different batches. For example, the batches 402 can comprise any suitable number of batches to ensure qubits acted on by a same two-qubit gate are in different batches. FIG. 6 illustrates a block diagram of an example, non-limiting system 600 that

can be employed to dynamically switch quantum circuit layouts in accordance with one or more embodiments described herein. Repetitive description of like elements and/or processes employed in respective embodiments is omitted for sake of brevity.

In some instances, qubits may be significantly influenced by TLS, making them resistant to mitigation through adjustments in TLS biases during quantum operations. For example, this can result due to the orientation of the qubit. As another example if the TLS bias involves an electric field, the shielding provided by superconducting metals can exacerbate this effect. However, such TLSs can still fluctuate over time, causing a qubit that is initially dominated by TLS to become a reliable qubit, or conversely, a previously stable qubit to begin to exhibit instability. To address this, when the quantum circuit 118 is smaller than (e.g., comprises less qubits) than the quantum system 112, qubit performance can be continuously reevaluated by measuring qubits 114 in the quantum system 112. This includes qubits that are being used in the quantum circuit 118 and qubits not being used in the quantum circuit 118. Further, this does not present any additional computational costs since measuring qubits in the quantum system 112 has no computational costs.

Therefore, measurement component 202 can measure qubits 114 throughout execution, and training component 204 can evaluate the performance of various circuit layouts based on the measurements. Based on the performance of the qubits 114, measurement component 202 can accordingly switch between circuit layouts of the quantum circuit 118. In various embodiments, switching between circuit layouts can be automated. That is, a performance threshold can be defined such that if the performance (e.g., error rate) exceeds the threshold or fails to satisfy the threshold, measurement component 202 can automatically switch layouts.

In various embodiments, as shown in FIG. 6, measurement component 202 can receive quantum circuit 118. Accordingly, measurement component 202 can determine if the quantum circuit 118 is smaller than quantum system 112.

If so, then measurement component 202 can determine a set of circuit layouts 602 of quantum circuit 118. In various aspects, measurement component 202 can pre-compile the circuit layouts 602 to enable automatic switching between circuit layouts 602. In various embodiments, measurement component 202 can determine any suitable number of circuit layouts 602. For instance, circuit layouts 602 can comprise k layouts: a layout 602(1) to a layout 602(k). In other cases, measurement component 202 can identify and compile additional circuit layouts during execution as needed in an automated process.

In any case, measurement component 202 can obtain periodic or continuous measurements of the qubits 114. Thereafter, if strong TLS are detected (e.g., via training component 204) for one or more qubits, measurement component 202 can switch the circuit layout to one of the circuit layouts 602 that does not involve the one or more qubits. This process can be carried out throughout execution to facilitate dynamic circuit layout switching, thus enabling error mitigation of poor performing qubits throughout execution without computational costs. For example, the quantum system 112 can comprise 150 qubits while the quantum circuit 118 only involves 50 contiguous qubits that meet connectivity requirements. Accordingly, measurement component 202 can determine which 50 qubits of the 150 qubits are best suited. This can mitigate problems in the circuit layouts 602 that are caused by unusable or poorly-performing gates that cannot be adequately mitigated via TLS bias. Further, since qubit performance can change or fluctuate, the measurement component 202 can collect measurements at defined intervals to enable continuous switching between circuit layouts.

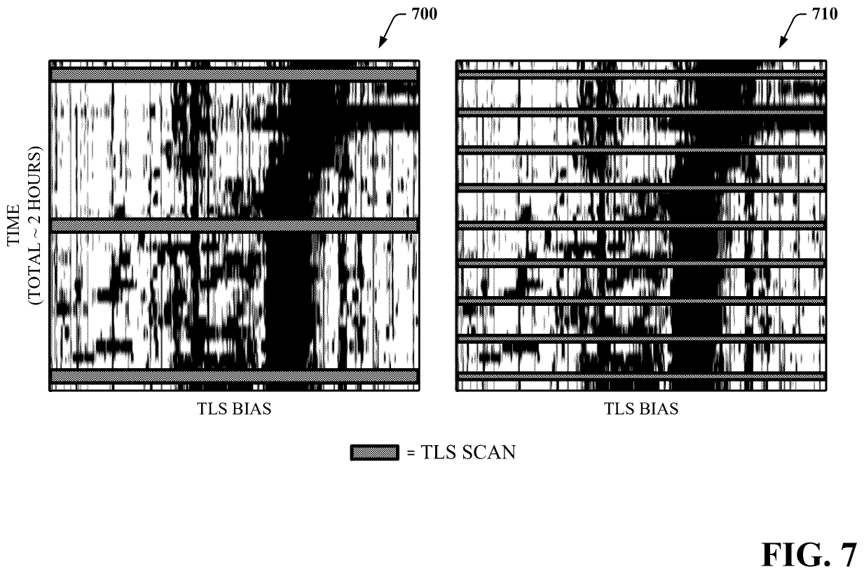

FIG. 7 illustrates a diagram of an example, non-limiting graphs 700 and 710 of TLS bias over time in accordance with one or more embodiments described herein. Repetitive description of like elements and/or processes employed in respective embodiments is omitted for sake of brevity.

Non-limiting graph 800 are intended to describe additional motivational aspects for the various embodiments described herein.

In various aspects, non-limiting graphs 700 and 710 illustrate TLS biases (x-axis) against time (y-axis). The y-axis depicts a total duration of approximately 2 hours. The horizontal blocks represent the intervals that measurements are obtained. In various embodiments, it can be desirable to determine an optimal TLS bias update schedule 304. Non-limiting graph graphs 700 and 710 are intended to illustrate why determining an optimal TLS bias update schedule 304 can be desirable.

To obtain reliable results in quantum computing, measurements must be obtained a plurality of times (e.g., hundreds of times). As shown in non-limiting graph 700, 3 measurements are taken, with each measurement lasting approximately 6 minutes. That is, non-limiting graph 700 employs an hourly scan and update of TLS biases. On average, the TLS biases are therefore based on prior measurements 120 that are 30 minutes old. Conversely, as shown in non-limiting graph 710, 9 measurements are taken, with each measurement lasting approximately 2 minutes. In other words, measurements can be obtained every 15 minutes at a similar overhead. At each measurement, TLS biases can be scanned and/or adjusted by measurement component 202. In any case, when the measurements last for shorter durations, such as in non-limiting graph 710) they can be insufficient to use individually. Therefore, measurement component 202 can combine the measurements (e.g., average the measurements). For instance, in non-limiting graph 710, measurement component 202 can average the last 4 measurements to have the same number of shots. Such approach can provide various advantages. For example, although the prior measurements 120 are, on average, still 30 minutes old, a smaller standard deviation can be achieved, resulting in a reduction of over-fitting to TLS fluctuations on timescales significantly less than 1 hour. That is, there will be a smaller cyclic variation in staleness of the prior measurements 120, achieving more stable error rates. Further, unequal weighting of the scans/measurements can be utilized to further improve error rates. Therefore, by determining and optimizing the TLS bas update schedule 404 for smaller time intervals and averaging multiple scans, a more stable error rate can be achieved with a less drastic variance. This can be especially advantageous for applications in PEC.

Moreover, as shown by non-limiting graphs 700 and 710, TLS can fluctuate significantly (white represents less TLS and black represents higher TLS). Various embodiments described herein can provide a method for responding to such TLS fluctuations quicker than existing methods by obtaining prior measurements 120 at frequent intervals and determining TLS biases 122 via ML model 210.

For example, with hourly TLS bias updates, if a dominant TLS comes into resonance, it can go unmitigated until the next update which can take about 30 minutes. Conversely, with continuous TLS bias updating, the “cost” for that bias immediately starts climbing. The worse the TLS, the less time it takes before that TLS bias is no longer favored. In other words, the various embodiments described herein can adjust to favor a different TLS bias faster as the TLS is worse. Thus, sudden TLS can be mitigated, improving error-rate stability by improving error-rate variations over time. As another advantage, because TLS details in TLS bias scans change over time, measurement component 202 can average over TLS biases for older measurement data to smooth out fluctuations, resulting in fewer needed scans to determine the optimal TLS biases 122.

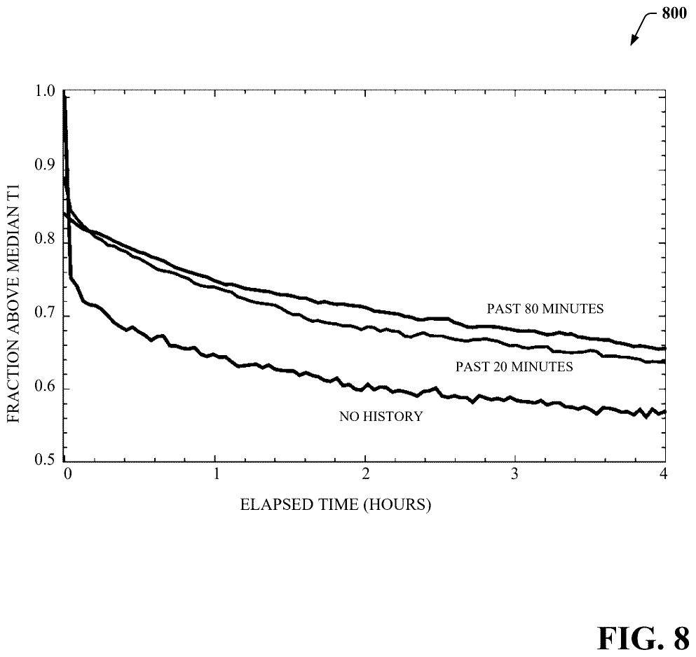

FIG. 8 illustrates a diagram of an example, non-limiting graph 800 of TLS bias selection performance in accordance with one or more embodiments described herein. Repetitive description of like elements and/or processes employed in respective embodiments is omitted for sake of brevity.

Non-limiting graph 800 are intended to describe additional motivational aspects for various embodiments described herein. In particular, non-limiting graph 800 depicts how measurements taken over longer time periods provide a more robust choice of TLS biases 122. As shown in non-limiting graph 800, T1 is measured using a single delay time with single qubit data. As illustrated, fitting to a single TLS sweep can cause the choice of TLS bias to be overly influenced by short-lied fluctuations, and thus can be detrimental to overall performance. More specifically, a TLS bias is selected and then 0 minutes, 20 minutes, and 80 minutes are waited. The results indicate that, although including older measurement data provides less improvement initially, it can increase the duration of the improvement. This suggests that there is some optimum averaging over past measurement data, which can be comprise by the non-limiting hyperparameters 300 of ML model 210. Accordingly, the various embodiments describe herein can be employed to determine such optimum averaging over past measurement data.

In various embodiments, the ML model 210 can model interleaving the measurements with the calculation being carried out. Thus, in short, frequent time increments with a minimal number of shots, measurement component 202 can update the TLS biases 122 with no additional overhead, and each update can use the entire measurement history up to that point. In various aspects, the entire measurement history can be represented in reference dataset 208. In various embodiments, measuring and updating the TLS biases 122 can be performed in a quasi-continuous manner to achieve more stable performance. Using short and frequent scans, measurement component 202 can combine the scans over a range of time and/or TLS biases 122 as determined by ML model 210 to have enough shots for a reliable estimate. Accordingly, the TLS biases 122 can be used briefly, as it is continually updates as new measurements are performed and the non-limiting system 100 receives such new measurements as prior measurements 120.

FIG. 9 illustrates a block diagram of an example, non-limiting training dataset in accordance with one or more embodiments described herein. Repetitive description of like elements and/or processes employed in respective embodiments is omitted for sake of brevity.

In various instances, the reference dataset 208 can be considered as a training dataset 900. In various aspects, the training dataset 900 can comprise a set of training inputs 902. That is, the set of training inputs 902 can be obtained from reference dataset 208. In various instances, the set of training inputs 902 can include q inputs for any suitable positive integer q: a training input 902(1) to a training input 902(q). In reference to FIG. 2, in various instances, each of the set of training inputs 902 can be performance data corresponding to the TLS biases 122 identified using the ML model 210.

In various aspects, the training dataset 900 can comprise a set of ground-truth annotations 904 that can respectively correspond to the set of training inputs 902. That is, the set of ground-truth annotations can be obtained from reference dataset 208. Accordingly, since the set of training inputs 902 can have q inputs, the set of ground-truth annotations 904 can have q annotations: a ground-truth annotation 904(1) to a ground-truth annotation 904(q). In various instances, each of the set of ground-truth annotations 904 can be one or more correct or accurate TLS biases that are known or deemed to correspond to a respective one of the set of training inputs 902. As a non-limiting example, the ground-truth annotation 904(1) can correspond to the training input 902(1). Accordingly, the ground-truth annotation 904(1) can be the correct or accurate TLS biases (e.g., correct or accurate TLS bias of one or more of qubits 114) that are known or deemed to correspond to the training input 902(1). As another non-limiting example, the ground-truth annotation 904(q) can correspond to the training input 902(q). Accordingly, the ground-truth annotation 904(q) can be the correct or accurate TLS biases that are known or deemed to correspond to the training input 902(q).

FIG. 10 illustrates an example, non-limiting block diagram 1000 showing how the ML model 210 can be trained in accordance with one or more embodiments described herein.

In various aspects, prior to beginning training, trainable internal parameters (e.g., convolutional kernels, weight matrices, bias values) of the ML model 210 can be initialized in any suitable fashion (e.g., via random initialization).

In various aspects, the training component 204 can select a training input 1002 and a ground-truth annotation 1004 corresponding to the training input 1002 from the training dataset 900. In various instances, the training component 204 can execute the ML model 210 on the training input 1002, thereby causing the ML model 210 to produce an output 1006. More specifically, in some cases, the training component 204 can feed the training input 1002 to the input layer of the ML model 210, the training input 1002 can complete a forward pass through the one or more hidden layers of the ML model 210, and the output layer of the ML model 210 can compute the output 1006 based on activation maps or feature maps provided by the one or more hidden layers of the ML model 210.

Note that the format, size, or dimensionality of the output 1006 can be dictated by the number, arrangement, sizes, or other characteristics of the neurons, convolutional kernels, or other internal parameters of the output layer (or of any other layers) of the ML model 210. Accordingly, the output 1006 can be forced to have any desired format, size, or dimensionality, by adding, removing, or otherwise adjusting characteristics of the output layer (or of any other layers) of the ML model 210. So, the output 1006 can be considered as the predicted TLS biases 122 that the ML model 210 believes should correspond to the training input 1002. In contrast, the ground-truth annotation 1004 can be considered as the correct or accurate TLS biases that is known or deemed to correspond to the training input 1002. Note that, if the ML model 210 has so far undergone no or little training, then the output 1006 can be highly inaccurate (e.g., can be very different from the ground-truth annotation 1004).

In various aspects, the training component 204 can compute any suitable error or loss (e.g., mean absolute error, mean squared error, cross-entropy error) between the output 1006 and the ground-truth annotation 1004. In various instances, the training component 204 can incrementally update the trainable internal parameters of the ML model 210, via backpropagation (e.g., stochastic gradient descent) driven by the computed error or loss.

In various cases, such execution-and-update procedure can be repeated for any suitable number of training inputs (e.g., for each training input in the training dataset 900). This can ultimately cause the trainable internal parameters of the ML model 210 to become iteratively optimized for accurately generating TLS biases 122 based on performance data. In various aspects, the training component 204 can implement any suitable training batch sizes, any suitable error, loss, or objective functions, or any suitable training termination criteria.

Although the above description mainly describes the ML model 210 as being trained in supervised fashion, this is a mere non-limiting example for ease of illustration and explanation. In various cases, the training component 204 can implement any other suitable training paradigms (e.g., unsupervised training, reinforcement learning) to train the ML model 210.

In various embodiments, if the training data is limited (e.g., few measurements and performance data are obtained for reference dataset 208), the ML model 210 can be initialized as a linear model. More specifically, in the linear model, a convolutions kernel can define a mapping between the measurement history to a TLS bias. To achieve this, training component 204 can convert the training data (e.g., the measurements and performance data) to a form where linear averaging is meaningful. For example, training component 204 can convert T1 to 1/T1.

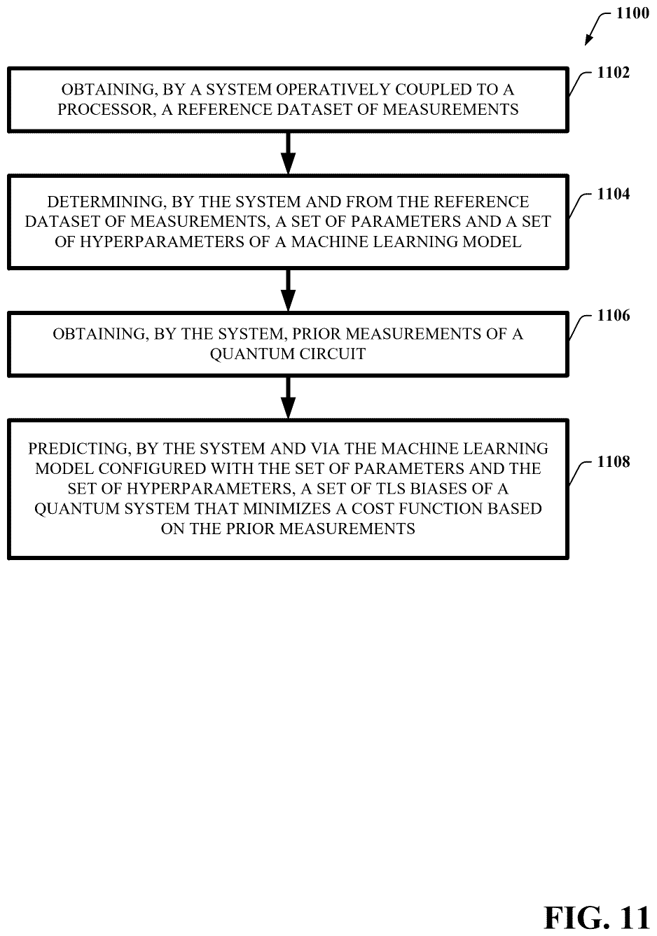

FIG. 11 illustrates a flow diagram of an example, non-limiting method 1100 that

can facilitate optimized TLS bias performance over measurement history in accordance with one or more embodiments described herein. Repetitive description of like elements and/or processes employed in respective embodiments is omitted for sake of brevity.

At 1102, non-limiting method 1100 can comprise obtaining (e.g., by measurement component 202), by a system operatively coupled to a processor, a reference dataset (e.g., 208) of measurements.

At 1104, non-limiting method 1100 can comprise determining (e.g., by training component 204), by the system and from the reference dataset of measurements, a set of parameters and a set of hyperparameters of a machine learning model (e.g., 210).

At 1106, non-limiting method 1100 can comprise obtaining (e.g., by measurement component 202), by the system, prior measurements (e.g., 120) of a quantum circuit (e.g., 118).

At 1108, non-limiting method 1100 can comprise predicting (e.g., by prediction component 206), by the system, and via the machine learning model configured with the set of parameters and the set of hyperparameters, a set of TLS biases (e.g., 122) of a quantum system that minimizes a cost function based on the prior measurements.

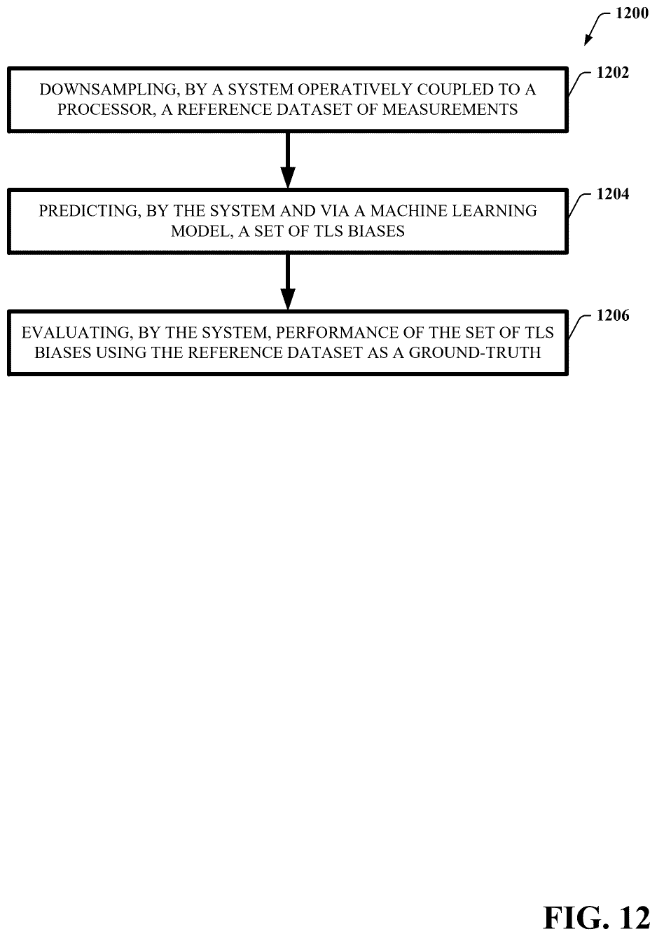

FIG. 12 illustrates a flow diagram of an example, non-limiting method 1200 that can facilitate optimized TLS bias performance over measurement history in accordance with one or more embodiments described herein. Repetitive description of like elements and/or processes employed in respective embodiments is omitted for sake of brevity.

At 1202, non-limiting method 1200 can comprise down sampling (e.g., by training component 204), by a system operatively coupled to a processor, a reference dataset (e.g., 208) of measurements.

At 1204, non-limiting method 1200 can comprise identifying (e.g., by training component 204), by the system, and via a machine learning model, a set of TLS biases.

At 1206, non-limiting method 1200 can comprise evaluating (e.g., by training component 204), by the system, performance of the set of TLS biases using the reference dataset as a ground-truth.

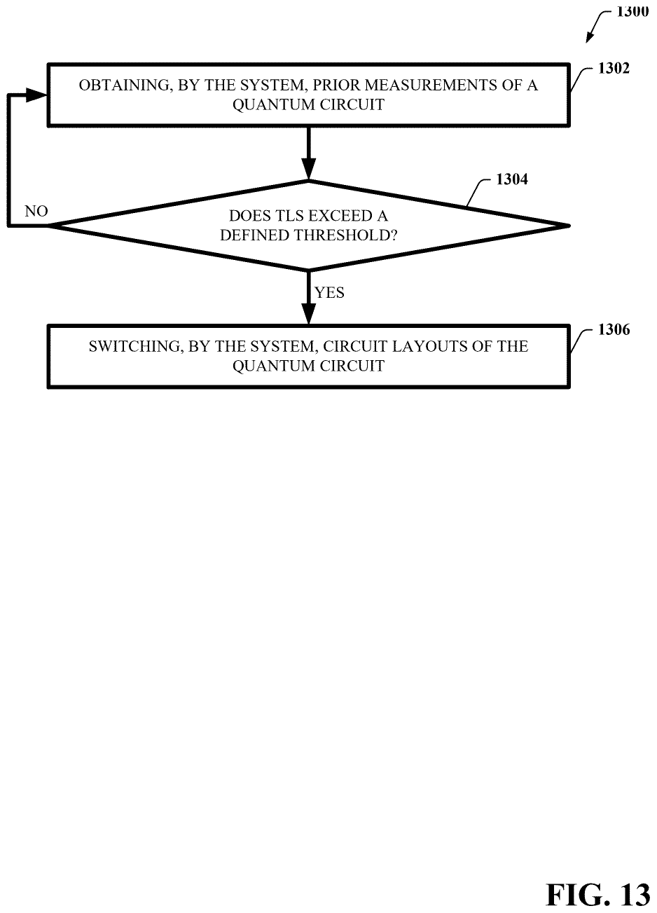

FIG. 13 illustrates a flow diagram of an example, non-limiting method 1300 that can facilitate optimized TLS bias performance over measurement history in accordance with one or more embodiments described herein. Repetitive description of like elements and/or processes employed in respective embodiments is omitted for sake of brevity.

At 1302, non-limiting method 1300 can comprise obtaining (e.g., by measurement component 202), by the system, prior measurements of a quantum circuit.

At 1304, non-limiting method 1300 can comprise determining (e.g., by measurement component 202), by the system, whether the TLS (e.g., TLS noise) exceeds a defined threshold.

If yes, then at 1306, non-limiting method 1300 can comprise switching (e.g., by measurement component 202), circuit layouts of the quantum circuit. If not, non-limiting method 1300 can proceed to 1302.

For example, if the TLS noise is too strong to mitigate by adjusting TLS biases, measurement component 202 can switch circuit layouts to avoid qubits that are prone to such noise, thereby improving error rates.

FIG. 14 illustrates a block diagram of an example, non-limiting, operating environment 1400 in which one or more embodiments described herein can be facilitated. FIG. 14 and the following discussion are intended to provide a general description of a suitable operating environment 1400 in which one or more embodiments described herein at FIGS. 1-13 can be implemented.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1400 contains an example of an environment for the execution of at least some of the computer code involved in performing the inventive methods, such as TLS bias prediction code 1428. In addition to block 1428, computing environment 1400 includes, for example, computer 1401, wide area network (WAN) 1402, end user device (EUD) 1403, remote server 1404, public cloud 1405, and private cloud 1406. In this embodiment, computer 1401 includes processor set 1410 (including processing circuitry 1420 and cache 1421), communication fabric 1411, volatile memory 1412, persistent storage 1413 (including operating system 1422 and block 1428, as identified above), peripheral device set 1414 (including user interface (UI) device set 1423, storage 1424, and Internet of Things (IoT) sensor set 1425), and network module 1415. Remote server 1404 includes remote database 1430. Public cloud 1405 includes gateway 1440, cloud orchestration module 1441, host physical machine set 1442, virtual machine set 1443, and container set 1444.

COMPUTER 1401 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1430. As is well understood in the art of computer technology, and depending upon the technology, performance of a computer-implemented method may be distributed among multiple computers and/or between multiple locations. On the other hand, in this presentation of computing environment 1400, detailed discussion is focused on a single computer, specifically computer 1401, to keep the presentation as simple as possible. Computer 1401 may be located in a cloud, even though it is not shown in a cloud in FIG. 14. On the other hand, computer 1401 is not required to be in a cloud except to any extent as may be affirmatively indicated.

PROCESSOR SET 1410 includes one, or more, computer processors of any type now known or to be developed in the future. Processing circuitry 1420 may be distributed over multiple packages, for example, multiple, coordinated integrated circuit chips. Processing circuitry 1420 may implement multiple processor threads and/or multiple processor cores. Cache 1421 is memory that is located in the processor chip package(s) and is typically used for data or code that should be available for rapid access by the threads or cores running on processor set 1410. Cache memories are typically organized into multiple levels depending upon relative proximity to the processing circuitry. Alternatively, some, or all, of the cache for the processor set may be located “off chip.” In some computing environments, processor set 1410 may be designed for working with qubits and performing quantum computing.

Computer-readable program instructions are typically loaded onto computer 1401 to cause a series of operational steps to be performed by processor set 1410 of computer 1401 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 1421 and the other storage media discussed below. The program instructions, and associated data, are accessed by processor set 1410 to control and direct performance of the inventive methods. In computing environment 1400, at least some of the instructions for performing the inventive methods may be stored in block 1428 in persistent storage 1413.

COMMUNICATION FABRIC 1411 is the signal conduction path that allows the various components of computer 1401 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 1412 is any type of volatile memory now known or to be developed in the future. Examples include dynamic type random access memory (RAM) or static type RAM. Typically, volatile memory 1412 is characterized by random access, but this is not required unless affirmatively indicated. In computer 1401, the volatile memory 1412 is located in a single package and is internal to computer 1401, but, alternatively or additionally, the volatile memory may be distributed over multiple packages and/or located externally with respect to computer 1401.

PERSISTENT STORAGE 1413 is any form of non-volatile storage for computers that is now known or to be developed in the future. The non-volatility of this storage means that the stored data is maintained regardless of whether power is being supplied to computer 1401 and/or directly to persistent storage 1413. Persistent storage 1413 may be a read only memory (ROM), but typically at least a portion of the persistent storage allows writing of data, deletion of data and re-writing of data. Some familiar forms of persistent storage include magnetic disks and solid state storage devices. Operating system 1422 may take several forms, such as various known proprietary operating systems or open source Portable Operating System Interface-type operating systems that employ a kernel. The code included in block 1428 typically includes at least some of the computer code involved in performing the inventive methods.

PERIPHERAL DEVICE SET 1414 includes the set of peripheral devices of computer 1401. Data communication connections between the peripheral devices and the other components of computer 1401 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1423 may include components such as a display screen, speaker, microphone, wearable devices (such as goggles and smart watches), keyboard, mouse, printer, touchpad, game controllers, and haptic devices. Storage 1424 is external storage, such as an external hard drive, or insertable storage, such as an SD card. Storage 1424 may be persistent and/or volatile. In some embodiments, storage 1424 may take the form of a quantum computing storage device for storing data in the form of qubits. In embodiments where computer 1401 is required to have a large amount of storage (for example, where computer 1401 locally stores and manages a large database) then this storage may be provided by peripheral storage devices designed for storing very large amounts of data, such as a storage area network (SAN) that is shared by multiple, geographically distributed computers. IoT sensor set 1425 is made up of sensors that can be used in Internet of Things applications. For example, one sensor may be a thermometer and another sensor may be a motion detector.

NETWORK MODULE 1415 is the collection of computer software, hardware, and firmware that allows computer 1401 to communicate with other computers through WAN 1402. Network module 1415 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1415 are performed on the same physical hardware device. In other embodiments (for example, embodiments that utilize software-defined networking (SDN)), the control functions and the forwarding functions of network module 1415 are performed on physically separate devices, such that the control functions manage several different network hardware devices. Computer-readable program instructions for performing the inventive methods can typically be downloaded to computer 1401 from an external computer or external storage device through a network adapter card or network interface included in network module 1415.

WAN 1402 is any wide area network (for example, the internet) capable of communicating computer data over non-local distances by any technology for communicating computer data, now known or to be developed in the future. In some embodiments, the WAN 1402 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1403 is any computer system that is used and controlled by an end user (for example, a customer of an enterprise that operates computer 1401), and may take any of the forms discussed above in connection with computer 1401. EUD 1403 typically receives helpful and useful data from the operations of computer 1401. For example, in a hypothetical case where computer 1401 is designed to provide a recommendation to an end user, this recommendation would typically be communicated from network module 1415 of computer 1401 through WAN 1402 to EUD 1403. In this way, EUD 1403 can display, or otherwise present, the recommendation to an end user. In some embodiments, EUD 1403 may be a client device, such as thin client, heavy client, mainframe computer, desktop computer and so on.

REMOTE SERVER 1404 is any computer system that serves at least some data and/or functionality to computer 1401. Remote server 1404 may be controlled and used by the same entity that operates computer 1401. Remote server 1404 represents the machine(s) that collect and store helpful and useful data for use by other computers, such as computer 1401. For example, in a hypothetical case where computer 1401 is designed and programmed to provide a recommendation based on historical data, then this historical data may be provided to computer 1401 from remote database 1430 of remote server 1404.

PUBLIC CLOUD 1405 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1405 is performed by the computer hardware and/or software of cloud orchestration module 1441. The computing resources provided by public cloud 1405 are typically implemented by virtual computing environments that run on various computers making up the computers of host physical machine set 1442, which is the universe of physical computers in and/or available to public cloud 1405. The virtual computing environments (VCEs) typically take the form of virtual machines from virtual machine set 1443 and/or containers from container set 1444. It is understood that these VCEs may be stored as images and may be transferred among and between the various physical machine hosts, either as images or after instantiation of the VCE. Cloud orchestration module 1441 manages the transfer and storage of images, deploys new instantiations of VCEs and manages active instantiations of VCE deployments. Gateway 1440 is the collection of computer software, hardware, and firmware that allows public cloud 1405 to communicate through WAN 1402.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1406 is similar to public cloud 1405, except that the computing resources are only available for use by a single enterprise. While private cloud 1406 is depicted as being in communication with WAN 1402, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1405 and private cloud 1406 are both part of a larger hybrid cloud.

CLOUD COMPUTING SERVICES AND/OR MICROSERVICES (not separately shown in FIG. 14): private and public clouds 1406 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer executable components;
a processor that executes the computer executable components stored in the memory, wherein the computer executable components comprise:
a measurement component that obtains a reference dataset of measurements;
a training component that determines, from the reference dataset of measurements, a set of parameters and a set of hyperparameters of a machine learning model; and
a prediction component that predicts, via the machine learning model configured with the set of parameters and the set of hyperparameters, a set of two-level-system (TLS) biases of a quantum system that minimizes a cost function based on prior measurements.

2. The system of claim 1, wherein the set of hyperparameters comprises at least one of: an update schedule of measurements, an update schedule of the set of TLS biases, types of measurements, or internal parameters of measurements.

3. The system of claim 1, wherein the training component trains the machine learning model to minimize the cost function using the reference dataset, wherein the reference dataset comprises TLS biases and corresponding performance data over a period of time.

4. The system of claim 1, wherein the training component independently adjusts the set of parameters or the set of hyperparameters for individual qubits of the quantum system.

5. The system of claim 1, wherein the training component generates alternative sets of parameters and hyperparameters of the machine learning model based on a target application of the quantum system.

6. The system of claim 5, wherein the cost function reflects the target application of the quantum system.

7. The system of claim 1, wherein the prior measurements are interleaved with a target experiment on the quantum system.

8. The system of claim 1, wherein the training component trains the machine learning model on crosstalk by generating controlled crosstalk in the reference dataset.

9. The system of claim 8, wherein generating controlled crosstalk in the reference dataset comprises:
dividing qubits of the quantum system into two or more batches, wherein two-qubit gates involve qubits from different batches in the two or more batches; and
independently scanning, on the quantum system, TLS biases on the two or more batches.

10. The system of claim 9, wherein the measurement component scans a subset of all combinations of the TLS biases on the two or more batches.

11. A computer-implemented method, comprising:
obtaining, by a system operatively coupled to a processor, a reference dataset of measurements;
determining, by the system, from the reference dataset of measurements, a set of parameters and a set of hyperparameters of a machine learning model; and
predicting, by the system and via the machine learning model configured with the set of parameters and the set of hyperparameters, a set of TLS biases of a quantum system that minimizes a cost function based on prior measurements.

12. The computer-implemented method of claim 11, wherein the set of hyperparameters comprises at least one of: an update schedule of measurements, an update schedule of the set of TLS biases, types of measurements, or internal parameters of measurements.

13. The computer-implemented method of claim 11, further comprising:
training, by the system, the machine learning model to minimize the cost function using the reference dataset, wherein the reference dataset comprises TLS biases and corresponding performance data over a period of time.

14. The computer-implemented method of claim 11, further comprising:
independently customizing, by the system, the set of parameters or the set of hyperparameters for individual qubits of the quantum system.

15. The computer-implemented method of claim 11, further comprising:
generating, by the system, alternative sets of parameters and hyperparameters of the machine learning model based on a target application of the quantum system, wherein the cost function reflects the target application of the quantum system.

16. The computer-implemented method of claim 11, wherein the prior measurements are interleaved with a target experiment on the quantum system.

17. The computer-implemented method of claim 11, further comprising:
training, by the system, the machine learning model on crosstalk by generating controlled crosstalk in the reference dataset, wherein generating controlled crosstalk in the reference dataset comprises:
dividing, by the system, qubits of the quantum system into two or more batches, wherein two-qubit gates involve qubits from different batches in the two or more batches; and
independently scanning, by the system, on the quantum system, TLS biases on the two or more batches.

18. A computer program product for optimizing performance of TLS biases, the computer program product comprising a computer readable storage medium having program instructions embodied therewith, the program instructions executable by a processor to cause the processor to:
obtain, by the processor, a reference dataset of measurements;
determine, by the processor, from the reference dataset of measurements, a set of parameters and a set of hyperparameters of a machine learning model; and
predict, by the processor and via the machine learning model configured with the set of parameters and the set of hyperparameters, a set of two-level-system (TLS) biases of a quantum system that minimizes a cost function based on prior measurements.

19. The computer program product of claim 18, wherein the set of hyperparameters comprises at least one of: an update schedule of measurements, an update schedule of the set of TLS biases, types of measurements, or internal parameters of measurements.

20. The computer program product of claim 18, wherein the program instructions executable by the processor further causes the processor to:
train, by the processor, the machine learning model to minimize the cost function using the reference dataset, wherein the reference dataset comprises TLS biases and corresponding performance data over a period of time.
